(19) United States
(12) Patent Application Publication
(10) Pub. No.: US 2006/0104357 A1
(43) Pub. Date: May 18, 2006

(54) Video coding

(76) Inventors: Dzevdet Burazerovic, Eindhoven (NL); Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/542,836

(22) PCT Filed: Jan. 19, 2004
(86) PCT No.: PCT/IB04/50035

§ 371 Date: Jul. 20, 2005

(30) Foreign Application Priority Data
Jan. 20, 2003 (EP) 03075199.4

(51) Int. Cl. H04N 11/04; H04N 7/12; H04B 1/66; H04N 11/02

(52) U.S. Cl. 375/240.15; 375/240.12; 375/240.24; 375/240.29; 375/240.18

(57) ABSTRACT

Coding of a video signal is provided according to a predefined standard, wherein in a given operation mode some of the tools provided by the predefined standard are disabled, and wherein an identification of the disabled tools is included in the bit-stream, the disabled tools being one or more out of the group of: bidirectional predictive coding of pictures or picture parts, use of a de-blocking filter, use of more than one reference picture.

During the recent years, a new ITU-T specification for video coding has been developed—H.26L, which has become broadly recognized for offering superior coding efficiency in comparison with the existing standards (“same signal-to-noise ratio for up to 50% less bits”). Although the gain of H.26L generally decreases in proportion to the picture size, the potential for its deployment in a broad range of applications is undoubted. This potential has been recognized through formation of the so-called Joint Video Team (“JVT”), having the task to finalize H.26L as a new joint ITU-T/MPEG industrial standard. The new standard is expected to be formally approved in 2003 as ITU-T H.264 or ISO/IEC MPEG-4 AVC (Advance Video Coding). In the meantime, H.264-based solutions are being considered in other standardization bodies, such as the DVB, DVD Forum and Blu-ray disk consortium, while SW/HW implementations of H.264 encoder/decoder are already becoming available. The development of H.264 is reflected in publicly accessible JVT documents like “Joint Final Committee Draft (JFCD) of Joint Video Specification (ITU-T Rec. H.264|ISO/IEC 14496-10 AVC)”, JVT-D157, generated 2002-08-10.

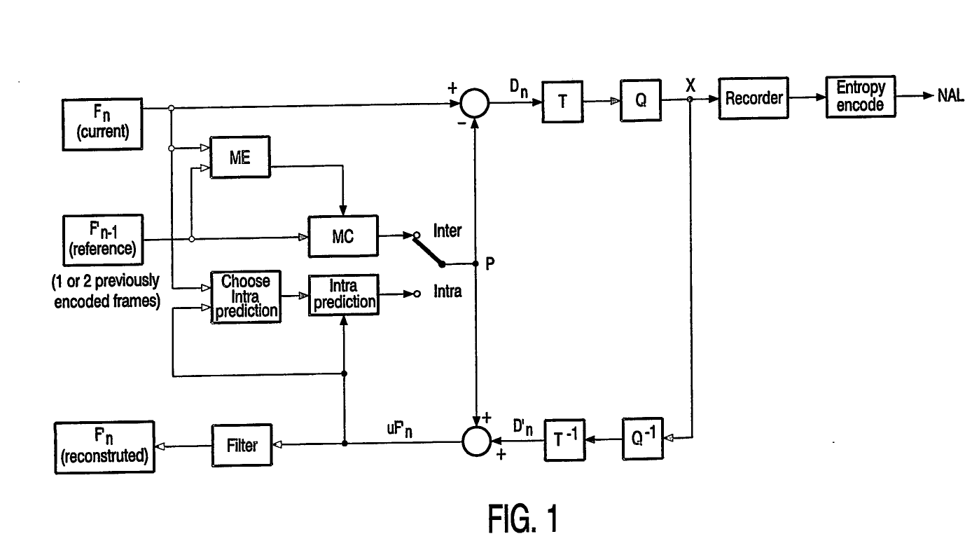

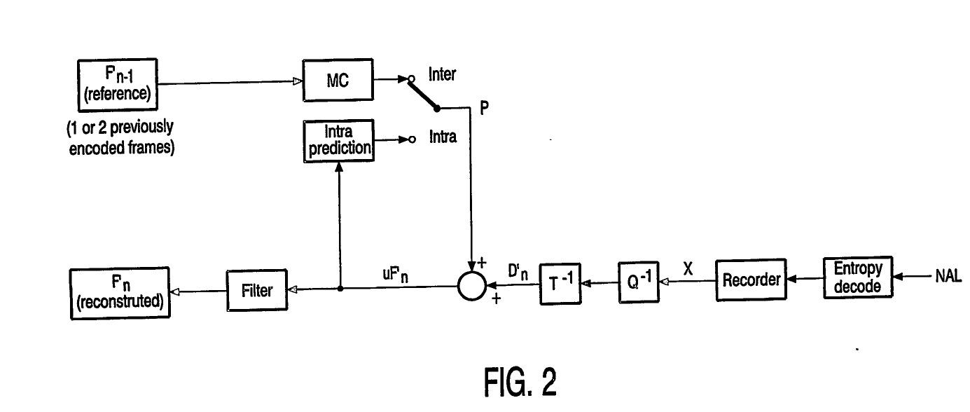

H.264 employs same principles of block-based motion-compensated hybrid transform coding that are known from the established standards such as MPEG-2. The H.264 syntax is, therefore, organized as the usual hierarchy of headers such as picture-, slice- and macro-block headers, and data such as motion-vectors, block-transform coefficients, quantizer scale, etc. Nevertheless, new syntax and coding methods are introduced at both the header level and the data level. A brief summary of some main particularities of H.264 is given below. The most relevant particularities for understanding the invention are subsequently explained in more detail in separate sections, taking JVT-D157 as reference. Typical block-diagrams illustrating H.264 encoding and decoding are given in FIGS. 1 and 2 in which “ME” is a Motion Estimation unit, “MC” is a Motion Compensation unit, “Q” is a Quantization unit, “Q⁻¹” is an Inverse Quantization unit, “T” is a Transform unit, “T⁻¹” is an InverseTransform unit, “Filter” is a de-blocking filter, “Fᵢ₋₁” is an i-th reference picture for inter prediction, and “NAL” is a Network Abstraction Layer.

H.264 separates the Video Coding Layer (“VCL”), which is defined to efficiently represent the content of the video data, and the Network Abstraction Layer, which formats data and provides header information in a manner appropriate for conveyance by the high level system. One of the main particularities of H.264 at the video data level is the use of more elaborate partitioning and manipulation of 16×16 macro-blocks. In H.264, the motion compensation process can form segmentations of a macro-block as small as 4×4 in size, using motion vector accuracy of one-fourth or one-eight of a sample grid. Also, the reference selection process for motion compensated prediction of a sample block can involve a number of stored previously decoded pictures, instead of only the adjoining ones. Even with intra coding, it is possible to form a prediction of a block using previously decoded samples, in that case from the same picture. The rules for this spatial-based prediction are described by the so-called intra prediction modes. After motion compensated- or spatial-based prediction, the resulting prediction error is normally transformed and quantized based on 4×4 block size, instead of the traditional 8×8 size. An additional provision called Adaptive Block Transform has been considered, which allows using multiple transforms to match the possible sizes of prediction blocks. But it is not yet clear whether this tool will be included in the final H.264 specification. The H.264 also uses new concepts in other coding stages. For example, H.264 departs from the usage of the DCT (Discrete Cosine Transform), which is used in previous standards such as MPEG-2. It also specifies different rules and designs for operations such as Entropy Coding or VLC (Variable Length Coding), quantization, etc. But, in contrast to the earlier explained concepts, most of these concepts only allow fixed implementation and are described by syntax elements which cannot be set-up below the sequence-, GOP- or picture level.

Motion Compensation

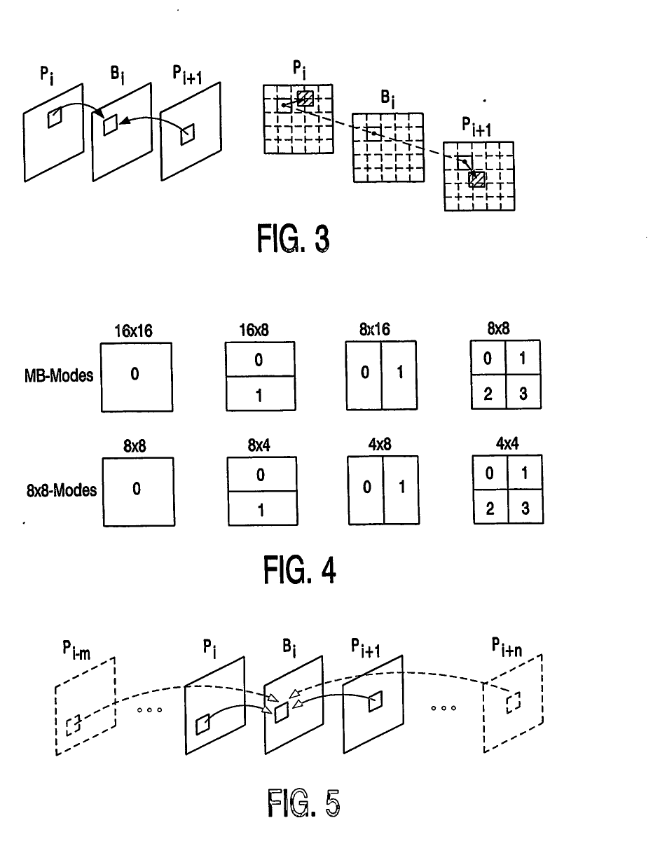

Most established video coding standards (e.g. MPEG-2) use block-based motion compensation as a practical method of exploiting correlation between subsequent pictures in video. This method attempts to predict each macro-block in a certain picture by its “best match” in an adjacent reference picture. This prediction is usually performed using only 16×16 luminance blocks, and the results of it are then also applied to the corresponding chrominance pixels. If the pixel-wise difference between a macro-block and its prediction is small enough, the prediction error, i.e. the difference between a macro-block and its prediction is encoded rather that the macro-block itself. The relative displacement of the prediction block with respect to the coordinates of the actual macro-block is indicated by a motion vector, which is coded separately. FIG. 3 illustrates the case of bidirectional prediction, where two reference pictures are used, one in the past and one in the future. Pictures that are predicted in this way are called B-pictures. Otherwise, pictures that are predicted only from past pictures are called P-pictures. Each macro-block in a B-picture can be predicted from a block from the past P-picture, or one from the future P-picture, or by an average of two blocks, each from a different P-picture. Much of the bit-rate savings offered by H.264 can be actually attributed to its improved methods of motion compensation. This is explained in more detail in the following subsections.

Multiple Prediction Block Sizes

In H.264, variable block size can be used for inter-, i.e. temporal prediction of a macro-block. Accordingly, a macro-block can be partitioned into a number of smaller blocks and each of these sub-blocks can be predicted separately (the prediction is still performed using only luma blocks. Hence, different sub-blocks can have different motion vectors and can even be retrieved from different reference pictures (see below). The number, size and orientation of prediction blocks is uniquely determined by definition of inter prediction modes, which describe possible partitioning of a macro-block into 8×8 sub-blocks and further partitioning of each its 8×8 sub-block. This is also shown in FIG. 4. The H.264 syntax includes elements such as mb_type and sub mb_type to indicate to a decoder which partition has been used with a certain macro block for the inter prediction. This is explained in more detail in Section 7.4.5 (Tables 7-12, 7-13, 7-16, 7-17) in JVT-D157.

Multiple Reference Pictures

In H.264, inter prediction for a certain macro-block can be formed by also taking blocks from more distant previously decoded future- or past pictures, instead only from the adjoining ones. This is referred to as multiple reference pictures and is illustrated in FIG. 5. The selection of a certain reference picture for prediction of a sub-block in a macro-block (see previous section) is indicated in the bitsream by the value of syntax elements ref_idx_{—}10 and ref dx_{—}11, see JVT-D157 Sec. 7.4.5.1.

De-Blocking Filter

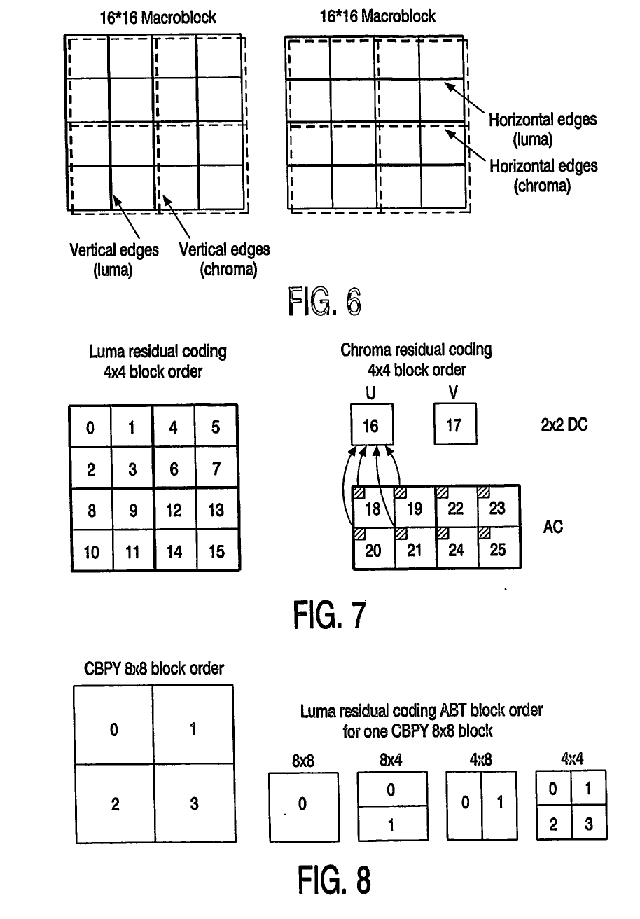

In H.264 conditional filtering is applied to all macro-blocks of a picture. For luma, as the first step, the 16 samples of the 4 vertical edges of the 4×4 raster shall be filtered beginning with the left edge, as shown in FIG. 6. Filtering of the 4 horizontal edges (vertical filtering) follows in the same manner, beginning with the top edge. The same ordering applies for chroma filtering, with the exception that 2 edges of 8 samples each are filtered in each direction. For each boundary between neighbouring 4×4 luma blocks, a “Boundary Strength” Bs is assigned. If Bs=0, filtering is skipped for that particular edge. In all other cases filtering is dependent on the local sample properties and the value of Bs for this particular boundary segment, see JVT-D157 Sec. 8.7. Several syntax elements are used to indicate in the bitstream whether the deblocking filter shall be applied to the edges controlled by the macro-blocks within the current slice and with which parameters. Such elements are e.g. disable_deblocking_filter_flag and slice_alpha_c0_offset_div2, see JVT-D157 Sec. 7.4.3.

Adaptive Block Transform

In H.264 the residual coding is by default performed using a 4×4 integer transform, which is similar but not compatible with the DCT (Discrete Cosine Transform) used in MPEG-2. Hence, the prediction error, i.e. the pixel-wise difference between a macro-block and its prediction, is divided into 16 luma 4×4 blocks and 8 chroma 4×4 blocks, as shown in FIG. 7. After the transformation, one DC coefficient is obtained for each 4×4 block, which gives 16 DC coefficients for the luma and 4 DC coefficients for each component of the chroma. The chroma DC coefficients are then grouped and transformed again, using another 2×2 transform. In recent drafts of H.264 transforms of size 4×8, 8×4, and 8×8 have been specified, in addition to the default 4×4 transform. This feature is called Adaptive Block Transform (ABT) and applies to the luma residual (the chroma residual coding process therefore remains as described above). The use of ABT is indicated in the bitsream by a parameter called adaptive_block_size_transform_flag, see JVT-D157, Section 12. In the case of inter coding, the size of a particular transform size will coincide with the block size used for prediction (see above). For intra macroblocks, the block size used for intra prediction is connected to the block size of the transformation. The order of the assignments of syntax elements for luma resulting from coding a macroblock to sub-blocks of the macroblock if the ABT features are used is shown in FIG. 8. A 8×8 block may contain 1, 2, or 4 transform blocks. An indication that an 8×8 block contains coefficients means that the 8×8 transform blocks or one or more of the 2, or 4 transform blocks within the 8×8 block contains coefficients. More details about the syntax and semantics of ABT can be found in Section 12 of JVT-D157.

One of the main purposes of development of H.264 was to respond to the growing need for substantially higher compression of moving pictures for applications such as video conferencing, internet streaming and communication, etc. Therefore, H.264 includes several coding tools that are suited for smaller picture formats and low bitrates being characteristic for such applications, but become less effective with the increase of the picture size. This is also confirmed by experiments with High Definition (HD) video, where it is generally observed that, at a certain point, an increase of the bitrate does not give a proportional increase of the picture quality in the situation where all the characteristic H.264 coding tools are enabled. In other words, even though some H.264 coding tools are responsible for achieving good picture quality at remarkably low bitrates, they seem less contributing, of even disturbing at higher bitrates. As in the case of de-blocking filtering, the H.264 syntax allows conditional operation of certain coding tools. However, in practical automated encoding, these conditions are determined by local low-level computations that usually attempt to minimize the bitrate rather than to preserve the picture quality. This implies that the typical H.264 operation can be inadequate for applications where bit rate constraints need not be as tight, yet virtually transparent picture quality should be achievable. Such an application is distribution of HD movies on discs with high storage capacity such as Blu-ray Disk (25 GB, 0.1 mm cover layer) or Blue DVD (15 GB, 0.6 mm cover layer). A particularly relevant problem of H.264 in this application area is that it has the tendency to remove the film grain, which effect is hardly reduced even when the bitrate is considerably increased, in the situation where typical H.264 coding settings used. The film grain refers to (slightly visible) noise that is introduced in film due to imperfection of recording equipment and environment, but has become so common that it is generally expected and is often even preferred by directors as a means for achieving a natural “film look”.

An object of the invention is to provide better quality for higher bit rates of a given coding standard. To this end, the invention provides a method of coding, an encoder, a coded bit-stream, a record carrier and a decoder as defined in the independent claims. Advantageous embodiments are defined in the dependent claims.

According to a first aspect of the invention, in a given operation mode, the coding disables some of the tools provided by the given coding standard, wherein an identification of the disabled tools is included in the bit-stream, the disabled tools being one or more out of the group of:
bidirectional predictive coding of pictures or picture parts
use of a de-blocking filter
use of more than one reference picture.

By providing an identification of the disabled tools, the encoder signals to a decoder that the disabled tools are not used. In the case the coding standard provides parameters or indicators that can be used to indicate disabled tools, the coded bit-stream can be implemented such that it remains compatible with the standard.

Preferably the given operation mode is a profile. A profile specifies the capabilities needed to decode the coded data, i.e. tools that may be used or may not be used by the encoder and thus the constraints on the bitstream syntax. A profile is typically constant over a piece of coded video content such as a movie.

In a preferred embodiment, adaptive block transforms are enabled.

Embodiments of the invention are described in relation to the H.264 standard although the invention is also applicable to other coding standards.

Embodiments of the invention will now be further explained with reference to the accompanying drawings in which

FIG. 1 shows a block diagram of a prior art H.264 encoder;

FIG. 2 shows a block diagram of a prior art H.264 decoder;

FIG. 3 illustrates the case of bi-directional prediction, where two reference pictures are used, one in the past and one in the future;

FIG. 4 illustrates possible partitioning of a macro-block into 8×8 sub-blocks and further partitioning of each its 8×8 sub-blocks in H.264;

FIG. 5 shows an illustration of the multiple reference pictures prediction in H.264, for the case of bi-directional prediction;

FIG. 6 illustrates how the de-blocking filtering is applied along several boundaries of a macro-block and within its sub-blocks;

FIG. 7 shows an illustration of 4×4 residual coding order in H.264;

FIG. 8 shows the ordering of blocks of CBPY (Coded Block Pattern) and luma residual coding of ABT blocks; and

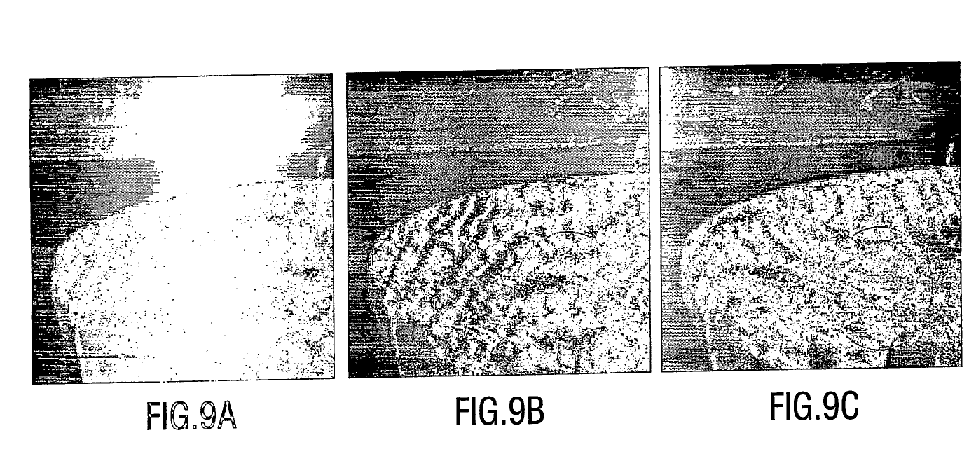

FIG. 9A shows an original piece of content and FIGS. 9B and 9C show a comparison of the result of a reference coder (9B) with a preferred embodiment of the invention (9C).

According to an embodiment of the invention, a HQ-HD profile of H.264 is proposed that can be used for high quality (virtually transparent) HD video compression, as intended for applications such as publishing of HD movies on high capacity digital carriers such as “Blu-ray disk”. Out of the many tools possible and allowed by the H.264 standard, only a very specific combination makes it possible to achieve at relative high bit-rates virtually transparent HDTV picture quality. This profile is obtained by selective exclusion of several standard H.264 coding tools or modes that the inventors have found to be not contributing or even disturbing for preserving virtually transparent picture quality at higher bit-rates. This exclusion can be easily indicated in the H.264 bit-stream, by enforcing or constraining certain values for several H.264 syntax elements. The benefit of such constraint of H.264 would not only be in that it would create unique conditions for approaching transparent picture quality while using H.264, but also in that it would enable construction of less complex H.264 encoders and decoders for this purpose. In this embodiment, the following mandatory exclusions/constraints of the standard coding tools that would uniquely define a profile:
Exclusion of B pictures/B slices (JVT-D157 Section 10)
Exclusion of the de-blocking filter (JVT-D157 Section 1.2.3)
Exclusion of at least one of the block sizes for inter prediction which are smaller than 8×8 (JVT-D157 Section 1.2.2.1)
Constraining the number of reference pictures to be used for prediction to 1 (JVT-D157 Sec. 1.2.2.2)

Although ABT is described in JVT-D157 (see section 12.4), it is considered for exclusion from the final H.264 specification. Nevertheless, in a preferred embodiment of the invention, ABT is included in this HQ-HD profile of H.264.

In addition to the disabling of standard H.264 coding tools and modes, the inventors recommend not to implement any kind of rate-distortion optimization in the H.264 such as the encoder rate-distortion optimization which is implemented in the JVT test software of H.264 encoder.

Embodiments of the invention can be directly implemented in a standard encoder such as the H.264 encoder shown in FIG. 1. Further, because it is not necessary for the encoder to be capable of using the disabled tools (e.g. for another operation mode), it is possible to provide a simple encoder with a reduced set of tools in combination with some means to include the correct parameters in the bit-stream to identify the disabled tools. As far as the disabled tools concern tools for which the standard provides an indicator indicating that the tool is not used, the simple encoder provides a compatible bit-stream.

### PRACTICAL EMBODIMENT

The following selective use of the tools of H.264 can provide almost transparent quality at bitrates of ˜15 Mbs:

TABLE I

| | reference | preferred |
|---|---|---|
| H.264 tools | all tools enabled | embodiment |
| GOP length | 12-24 | 12 |
| Number of B frames | 1 or 2 | 0 |
| Q_par (B) | Q_par(P) + 1 | not applicable |
| De-blocking filter | Enabled | Disabled |
| RD optimization | Enabled | Disabled |
| InterSearch 16 × 16 | Enabled | Enabled |
| InterSearch 16 × 8 | Enabled | Enabled |
| InterSearch 8 × 16 | Enabled | Enabled |
| InterSearch 8 × 4 | Enabled | Disabled |
| InterSearch 4 × 8 | Enabled | Disabled |
| InterSearch 4 × 4 | Enabled | Disabled |
| Number Reference Frames | 2-5 | 1 |

The use of Adaptive Block Transforms is preferred.

FIGS. 9B and 9C show a comparison of the reference (9B) with the preferred embodiment (9C) indicating that the preferred embodiment leads to a significant increase in quality. FIG. 9A shows the original piece of content.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not disable the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of coding a video signal according to a predefined standard, wherein in a given operation mode some of the tools provided by the predefined standard are disabled, and wherein an identification of the disabled tools is included in the bit-stream, the disabled tools being one or more out of the group of:
bidirectional predictive coding of pictures or picture parts
use of a de-blocking filter
use of more than one reference picture.

2. A method as claimed in claim 1, wherein the given operation mode is a profile.

3. A method as claimed in claim 2, wherein the profile is used to code high definition video content such as a high definition movie.

4. A method as claimed in claim 1, wherein bidirectionally predicively coded pictures and/or slices are disabled, wherein the de-blocking filter is disabled, wherein at least one of the block sizes for inter prediction which are smaller than 8×8 pixels is excluded and wherein the the number of reference pictures to be used for prediction is constrained to one.

5. A method as claimed in claim 4, wherein all block sizes for inter prediction which are smaller than 8×8 pixels are excluded.

6. A method as claimed in claim 1, wherein the coding uses no rate-distortion optimization.

7. A method as claimed in claim 1, wherein adaptive block size transforms are used.

8. A method as claimed in claim 1, wherein the group of picture length is fixed to 12.

9. A method as claimed in claim 1, wherein the coding is performed in conformance with the H.264 standard.

10. An encoder comprising means for coding a video signal according to a predefined standard, wherein in a given operation mode some of the tools provided by the predefined standard are disabled,
means for including an identification of the disabled tools in the bit-stream, the disabled tools being one or more out of the group of:
bidirectional predictive coding of pictures or picture parts
use of a de-blocking filter
use of more than one reference picture.

11. A coded bit-stream representing a video signal, the bit-stream including an identification of disabled tools, which disabled tools were disabled in the coding of the coded bit-stream, the disabled tools being one or more out of the group of:
bidirectional predictive coding of pictures or picture parts
use of a de-blocking filter
use of more than one reference picture.

12. A record carrier having stored thereon a coded bit-stream as claimed in claim 11.

13. A decoder for decoding a coded bit-stream as claimed in claim 11, wherein the decoder is in conformance with a predefined standard except that it is constraint by not providing the disabled tools.
